(19) United States
(12) Patent Application Publication
(10) Pub. No.: US 2024/0347827 A1
(43) Pub. Date: Oct. 17, 2024

(54) BUTTON CELL

(71) Applicant: SAMSUNG SDI CO., LTD., Yongin-si (KR)

(72) Inventor: Dae-Sup KIM, Yongin-si (KR)

(21) Appl. No.: 18/614,341

(22) Filed: Mar. 22, 2024

(30) Foreign Application Priority Data
Apr. 12, 2023 (KR) 10-2023-0048345

(51) Int. Cl. H01M 50/171; H01M 10/04; H01M 50/109; H01M 50/153; H01M 50/536

(52) U.S. Cl. CPC H01M 50/171; H01M 10/0427; H01M 50/109; H01M 50/153; H01M 50/536

(57) ABSTRACT

A button cell includes an electrode assembly including a first electrode, a second electrode, and a separator between the first electrode and the second electrode; a case connected to the first electrode, housing the electrode assembly, and including an opening exposing the electrode assembly and a side wall defining the opening; a cap plate connected to the second electrode, insulated from and bonded to the side wall of the case, and covering the opening; and a bonding layer located between the cap plate and the side wall of the case, and insulating and bonding the case and the cap plate.

### CROSS-REFERENCE TO RELATED APPLICATION

The present application claims priority to and the benefit of Korean Patent Application No. 10-2023-0048345, filed on Apr. 12, 2023 in the Korean Intellectual Property Office, the entire disclosure of which is incorporated herein by reference.

### BACKGROUND

### 1. Field

Aspects of embodiments of the present disclosure relate to a button cell.

### 2. Description of the Related Art

Generally, a rechargeable battery is a battery that may be repeatedly charged and discharged.

Recently, as the demand for wearable devices, such as headphones, earphones, smartwatches, and body-attached medical devices, and the use of wireless communication, such as Bluetooth, has increased, the need for ultra-small rechargeable batteries to be mounted on the wearable devices is increasing.

A conventional button cell may include a case receiving an electrode assembly and connected to a first electrode of the electrode assembly, a cap plate welded to the case, and a terminal plate insulated and joined to the cap plate by a bonding layer and connected to a second electrode of the electrode assembly.

However, in the conventional button cell, as the case and the cap plate are welded while the electrode assembly is accommodated inside the case, there is a problem in that the separator included in the electrode assembly may be damaged due to welding heat, resulting in a short circuit between the first electrode and the second electrode of the electrode assembly.

### SUMMARY

According to an aspect of embodiments of the present disclosure, a button cell that prevents (prevents or substantially prevents) damage from welding heat and external interference is provided.

According to one or more embodiments, a button cell includes an electrode assembly including a first electrode, a second electrode, and a separator between the first electrode and the second electrode; a case connected to the first electrode, housing the electrode assembly, and including an opening exposing the electrode assembly and a side wall forming the opening; a cap plate connected to the second electrode, insulated from and bonded to the side wall of the case, and covering the opening; and a bonding layer located between the cap plate and the side wall of the case and insulated and bonded between the case and the cap plate.

The cap plate may not protrude to an outside of the side wall of the case.

The outside of the side wall of the case may include an outside in a horizontal direction and a vertical direction of the button cell.

The side wall of the case may include a step part that is recessed from an end of the side wall and in contact with the bonding layer.

The cap plate may be inserted in the step part.

The bonding layer may be located between the step part and an edge of the cap plate.

The edge of the cap plate may include a rear surface facing a bottom of the step part; a front surface opposite to the rear surface; and a side surface connecting the rear surface and the front surface.

The bonding layer may include a first part that is in contact with the rear surface of the edge of the cap plate.

The bonding layer may further include a second part that extends from the first part and is in contact with the side surface of the edge of the cap plate.

The bonding layer may further include a third part that extends from the second part and is contact with the front surface of the edge of the cap plate.

The bonding layer may further include a fourth part that extends from the second part and is in contact with the end of the side wall.

The bonding layer may further include a fifth part that extends from the first part and is contact with an inner surface of the side wall.

The cap plate may not be welded to the case.

The cap plate may be a flat plate that completely covers the opening.

The bonding layer may be in a form of a loop that is in contact with an edge of the cap plate and the side wall of the case.

The electrode assembly may further include a first electrode tab that extends from the first electrode and is welded to the case; and a second electrode tab that extends from the second electrode and is welded to the cap plate.

The case may have a same polarity as the first electrode, and the cap plate may have a same polarity as the second electrode.

According to one or more embodiments, the button cell that prevents (prevents or substantially prevents) damage due to welding heat and damage due to external interference is provided.

### BRIEF DESCRIPTION OF DRAWINGS

FIG. 1 is a perspective view showing a button cell according to an embodiment.

FIG. 2 is a cross-sectional view taken along the line II-II of FIG. 1.

FIG. 3 is an enlarged view of a region “A” of FIG. 2.

FIG. 4 is a cross-sectional view showing a region of a button cell according to another embodiment.

FIG. 5 is a cross-sectional view showing a region of a button cell according to another embodiment.

FIG. 6 is a cross-sectional view showing a region of a button cell according to another embodiment.

FIG. 7 is a cross-sectional view showing a region of a button cell according to another embodiment.

FIG. 8 is a cross-sectional view showing a region of a button cell according to another embodiment.

FIG. 9 is a cross-sectional view showing a region of a button cell according to another embodiment.

FIG. 10 is a cross-sectional view showing a region of a button cell according to another embodiment.

### DESCRIPTION OF SYMBOLS

| | |
|---|---|
| electrode assembly 100; | case 200; |
| cap plate 300; | bonding layer 400 |

### DETAILED DESCRIPTION

The present disclosure will be described more fully herein with reference to the accompanying drawings, in which some embodiments of the present disclosure are shown. However, as those skilled in the art would realize, the described embodiments may be modified in various different ways, all without departing from the spirit or scope of the present disclosure.

In addition, unless explicitly described to the contrary, the word “comprise,” and variations such as “comprises” or “comprising” are to be understood to imply the inclusion of stated elements but not the exclusion of any other elements.

Also, in this specification, it is to be understood that when one component is referred to as being “connected” or “coupled” to another component, it may be connected or coupled directly to the other component or connected or coupled to another component with one or more other components intervening therebetween.

Singular forms are to include plural forms unless the context clearly indicates otherwise.

It is to be understood that, although the terms “first,” “second,” etc. may be used herein to describe various elements, these elements should not be limited by these terms. These terms are used to distinguish one element from another. For example, a first element could be termed a “second” element, and, similarly, a second element could be termed a “first” element, without departing from the scope of example embodiments of the inventive concept. The terms of a singular form may include plural forms unless the context clearly indicates otherwise.

In addition, terms such as “below,” “lower,” “above,” “upper,” and the like are used to describe the relationship of the configurations shown in the drawings. However, the terms are used as a relative concept and are described with reference to the direction indicated in the drawings.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

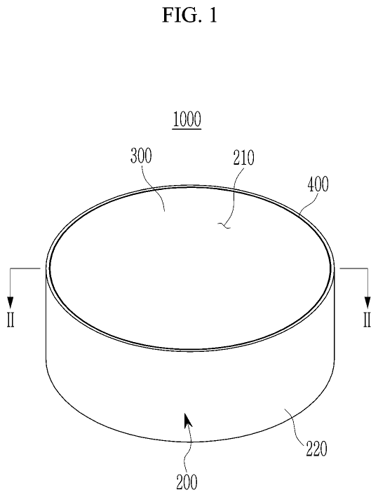

Herein, a button cell according to an embodiment is described with reference to FIG. 1 to FIG. 3.

A button cell according to an embodiment is an ultra-small rechargeable battery and may include a coin cell, but it is not limited thereto and may include a cylindrical or pin-type battery.

Here, a button cell is a thin coin or button-shaped battery, and may refer to a battery with a ratio of height to diameter (height/diameter) of 1 or less, but is not limited thereto. In one or more embodiments, the button cell is cylindrical, such that a cross-section in the horizontal direction is circular, but the present disclosure is not limited thereto, and the cross-section in the horizontal direction may have a shape of an oval or a polygon. The diameter may refer to the maximum distance based on the horizontal direction of the battery, and the height may refer to the maximum distance (the distance from a flat bottom surface to an uppermost surface) based on the vertical direction of the battery.

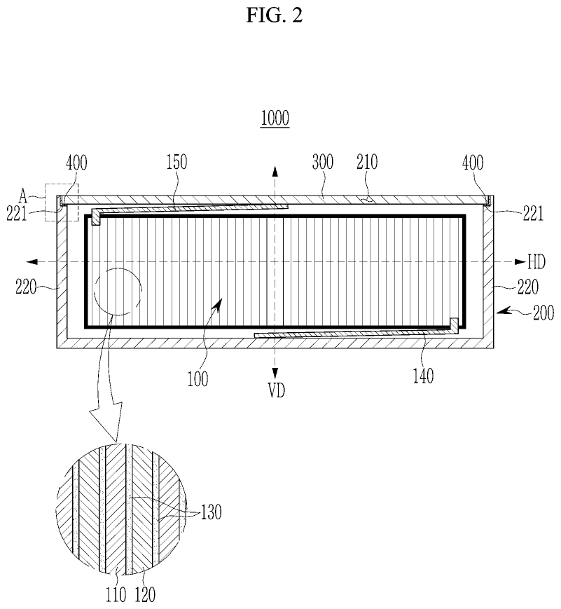

FIG. 1 is a perspective view showing a button cell according to an embodiment; and FIG. 2 is a cross-sectional view along the line II-II of FIG. 1.

Referring to FIG. 1 and FIG. 2, a button cell 1000 according to an embodiment is a rechargeable battery that may be repeatedly charged and discharged, and includes an electrode assembly 100, a case 200, a cap plate 300, and a bonding layer 400.

The electrode assembly 100 is accommodated in the case 200. A lower part of the electrode assembly 100 faces a bottom of the case 200, and an upper part of the electrode assembly 100 faces the cap plate 300 that covers an opening 210 of the case 200. The upper and lower parts of the electrode assembly 100 may have a planar shape and be parallel to each other, but are not limited thereto.

The electrode assembly 100 includes a first electrode 110, a second electrode 120, a separator 130, a first electrode tab 140, and a second electrode tab 150.

The first electrode 110 and the second electrode 120 are spaced apart from each other, and the separator 130 for insulation is positioned between the first electrode 110 and the second electrode 120. The first electrode 110 may be an anode, and the second electrode 120 may be a cathode, but the present disclosure is not limited thereto, and the first electrode 110 may be a cathode, and the second electrode 120 may be an anode.

In an embodiment, the first electrode 110 has a band shape extending in a direction, and may include an anode coated region as a region where an anode active material layer is applied on a current collector of a metal foil (for example, a Cu foil) and an anode uncoated region where the active material is not coated. The anode uncoated region may be positioned at an end in an extension direction of the first electrode 110.

The second electrode 120 may be spaced apart from the first electrode 110 with the separator 130 therebetween, have a band shape extending in a direction, and include a cathode coated region where a cathode active material layer is applied on a current collector of a metal foil (for example, an Al foil) and a cathode uncoated region where an active material is not applied.

The cathode uncoated region may be positioned at an end in the extension direction of the second electrode 120.

The separator 130 extends in a direction between the first electrode 110 and the second electrode 120 to prevent or substantially prevent a short circuit between the first electrode 110 and the second electrode 120.

The first electrode 110, the separator 130, and the second electrode 120 may be sequentially stacked and wound in a jelly roll shape centered in a vertical direction VD, but are not limited thereto, and may be formed in any of various known shapes. Here, the vertical direction VD includes a thickness direction or a height direction of the button cell 1000, but is not limited thereto.

The first electrode tab 140 extends from the first electrode 110 of the electrode assembly 100 to the bottom of the case 200. The first electrode tab 140 is combined with the bottom of the case 200 and connects the first electrode 110 and the case 200. The first electrode tab 140 is in contact with the first electrode 110 and the case 200. In an embodiment, the first electrode tab 140 is welded to the bottom of the case 200, but the present disclosure is not limited thereto, and the first electrode tab 140 may be in contact with the bottom of the case 200. The case 200 has a same polarity as that of the first electrode 110 due to the first electrode tab 140.

The second electrode tab 150 extends from the second electrode 120 of the electrode assembly 100 to the cap plate 300. The second electrode tab 150 is combined with the cap plate 300 to connect the second electrode 120 and the cap plate 300. The second electrode tab 150 is in contact with the second electrode 120 and the cap plate 300. In an embodiment, the second electrode tab 150 is welded to a rear, or lower, surface of the cap plate 300, but the present disclosure is not limited thereto, and may be in contact with the rear surface of the cap plate 300. Due to the second electrode tab 150, the cap plate 300 has a same polarity as the second electrode 120.

In an embodiment, a center pin penetrating a center of the electrode assembly 100 in the vertical direction VD may be positioned in a central part of the electrode assembly 100, and the center pin may support each of the first electrode tab 140 and the second electrode tab 150 to the case 200 and the cap plate 300, but the present disclosure is not limited thereto. For example, the center pin may have a pillar shape with a space formed at a center in the vertical direction VD, but the center pin is not limited thereto and may have any of various known shapes.

The case 200 is connected to the first electrode 110 of the electrode assembly 100 and accommodates the electrode assembly 100. The case 200 includes an opening 210 that exposes the upper part of the electrode assembly 100 and a side wall 220 that forms, or defines, the opening 210.

The opening 210 of the case 200 may be formed by the side wall 220 extending (e.g., by bending) in the vertical direction VD from the bottom of the case 200, but is not limited thereto. The bottom of the case 200 is welded to the first electrode tab 140 and connected to the first electrode 110 of the electrode assembly 100, such that the case 200 has the same polarity as the first electrode 110. In an embodiment, the case 200 is a cylinder-shaped can that accommodates the jelly roll-shaped electrode assembly 100, but the present disclosure is not limited thereto and may have any of various known shapes. The case 200 may accommodate any of various known electrolyte solutions together with the electrode assembly 100. An external surface of the case 200 may be a first electrode terminal of the button cell 1000, but the present disclosure is not limited thereto. In an embodiment, a front surface, which is an external surface of the cap plate 300, may be a second electrode terminal of the button cell 1000, but the present disclosure is not limited thereto. In an embodiment, a plating layer may be coated on the external surface of the case 200, but the present disclosure is not limited thereto and various known coating layers may be coated on the external surface of the case 200. In an embodiment, the case 200 may include stainless steel, but is not limited thereto and may include any of various known metals. The opening 210 of the case 200 is completely covered by the cap plate 300.

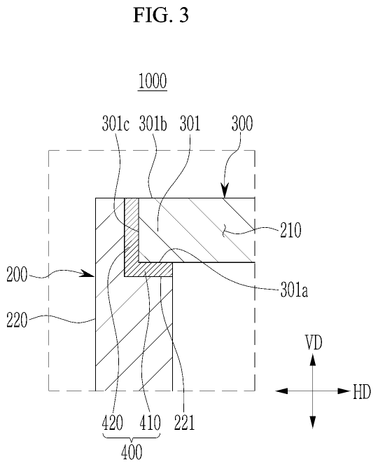

FIG. 3 is an enlarged view of a region “A” of FIG. 2.

Referring to FIG. 3 and FIG. 2, the side wall 220 of the case 200 includes a step part 221 recessed from an end of the side wall 220 corresponding to the cap plate 300.

In an embodiment, the step part 221 is depressed in the vertical direction VD in a loop shape in a plan view along an edge 301 of the cap plate 300, but is not limited thereto. The step part 221 is in contact with the bonding layer 400, and the bonding layer 400 and the cap plate 300 are inserted into the step part 221. By inserting the cap plate 300 into the step part 221 of the side wall 220 of the case 200, the side wall 220 of the case 200 completely covers the cap plate 300 in a horizontal direction HD. For example, the step part 221 may include a plurality of step parts connected to each other, and, correspondingly, the cap plate 300 may include a plurality of other step parts inserted into the plurality of step parts in response to the plurality of step parts.

The cap plate 300 is connected to the second electrode 120 and is insulated and bonded to the side wall 220 of the case 200 by the bonding layer 400. In an embodiment, the cap plate 300 has a flat plate shape, and completely covers the opening 210 of the case 200 in the vertical direction VD. The cap plate 300 seals (e.g., tightly seals) the electrode assembly 100 together with the case 200 and the bonding layer 400. The cap plate 300 is coupled to the second electrode tab 150 of the electrode assembly 100 and connected to the second electrode 120 of the electrode assembly 100. The cap plate 300 has the same polarity as that of the second electrode 120. The rear surface of the cap plate 300 may be combined with the second electrode tab 150, and the front surface of the cap plate 300 may be the second electrode terminal of the button cell 1000. The rear surface of the cap plate 300 may be welded to the second electrode tab 150, but is not limited thereto. In an embodiment, a plating layer may be coated on the external surface of the cap plate 300, but the present disclosure is not limited thereto, and any of various known coating layers may be coated on the external surface of the cap plate 300. In an embodiment, the cap plate 300 includes aluminum, but is not limited thereto, and may include any of various known metals.

The cap plate 300 is inserted into the step part 221 of the side wall 220 of the case 200 and completely covers the opening 210 of the case 200 in the vertical direction VD. In an embodiment, the cap plate 300 is inserted into the step part 221 of the side wall 220 of the case 200 and the side wall 220 of the case 200 completely covers the cap plate 300 in the horizontal direction HD. As a result, the cap plate 300 does not protrude to the outside of the side wall 220 of the case 200. For example, the outside of the side wall 220 of the case 200 includes the outside of the horizontal direction HD and the vertical direction VD of the button cell 1000, and the cap plate 300 does not protrude from the side wall 220 of the case 200 to the outside of the vertical direction VD and the horizontal direction HD. As a result, an interference of the cap plate 300 with other external components may be prevented. Here, the horizontal direction HD intersects the vertical direction VD and includes a diameter direction of the button cell 1000, and the vertical direction VD includes the thickness direction or the height direction of the button cell 1000. In an embodiment, in a state in which the bonding layer 400 is positioned between the cap plate 300 and the step part 221 of the side wall 220 of the case 200, the cap plate 300 is insulated and bonded to the case 200 by the bonding layer 400 by applying a pressure between the cap plate 300 and the step part 221 of the side wall 220 of the case 200. In other words, the cap plate 300 is not welded to the case 200 and is bonded to the case 200. The bonding layer 400 may have any of various forms according to unique characteristics of a non-welding closing/sealing manufacturing method of rolling between the cap plate 300 and the step part 221 of the side wall 220.

The edge 301 of the cap plate 300 is a part inserted into the step part 221 of the side wall 220 of the case 200, and the bonding layer 400 is positioned between the step part 221 of the side wall 220 and the edge 301 of the cap plate 300 along the edge 301. The edge 301 of the cap plate 300 includes a rear surface 301a facing the bottom of the step part 221, a front surface 301b positioned on an opposite side of the rear surface 301a, and a side surface 301c connecting the rear surface 301a and the front surface 301b. In an embodiment, the bonding layer 400 is in contact with the rear surface 301a and the side surface 301c of the edge 301 of the cap plate 300.

The bonding layer 400 is positioned between the edge 301 of the cap plate 300 and the step part 221 of the side wall 220 of the case 200. The bonding layer 400 insulates and bonds the case 200 and the cap plate 300, such that the cap plate 300 is insulatedly bonded to the case 200 by the bonding layer 400. In an embodiment, the bonding layer 400 has a loop shape that contacts the edge 301 of the cap plate 300 and the step part 221 of the side wall 220 of the case 200 by pressing or rolling between the cap plate 300 and the case 200, but it is not limited thereto. The bonding layer 400 prevents or substantially prevents a short circuiting between the case 200 and the cap plate 300. As the bonding layer 400 bonds between the cap plate 300 and the case 200, the opening 210 of the case 200 in which the electrode assembly 100 is stored is completely sealed by the cap plate 300 and the bonding layer 400. In an embodiment, the bonding layer 400 may include polypropylene and/or polyimide, but it is not limited thereto, and may include any of various known resins that insulate and bond the cap plate 300 and the case 200. For example, the bonding layer 400 may include any of a thermosetting resin and a thermoplastic resin. The thermosetting resin of the bonding layer 400 may include any of various known thermosetting resins, such as phenol resin, urea resin, melamine resin, epoxy resin, and polyester resin. In an embodiment, the thermoplastic resin of the bonding layer 400 includes polypropylene resin, but is not limited thereto, and may include any of various known thermoplastic resins, such as polystyrene, polyethylene, and polyvinyl chloride resin.

In an embodiment, the bonding layer 400 is in contact with the rear surface 301a and the side surface 301c of the edge 301 of the cap plate 300, and is not in contact with the front surface 301b of the edge 301 of the cap plate 300. The bonding layer 400 includes a first part 410 and a second part 420. The first part 410 is in contact with the rear surface 301a of the edge 301 of the cap plate 300, and the second part 420 extends from the first part 410 and is contact with the side surface 301c of the edge 301 of the cap plate 300. The bonding layer 400 is positioned at the step part 221 of the side wall 220 of the case 200 and includes the first part 410 and the second part 420 which are in contact with the rear surface 301a and the side surface 301c of the edge 301 of the cap plate 300 inserted in the step part 221, thereby preventing or substantially preventing a short circuit between the case 200 and the cap plate 300.

As described above, in the button cell 1000 according to an embodiment, the cap plate 300 covering the opening 210 of the case 200 connected to the first electrode 110 of the electrode assembly 100 is connected to the second electrode 120 to be insulated from and bonded to the side wall 220 of the case 200 by the bonding layer 400 such that the cap plate 300 is not welded to the case 200, the separator 130 of the electrode assembly 100 is not damaged by welding heat, and the first electrode 110 and the second electrode 120 of the electrode assembly 100 are not short circuited.

Also, in the button cell 1000 according to an embodiment, the cap plate 300 does not protrude to the outside of the horizontal direction HD and the vertical direction VD of the side wall 220 of the case 200 such that interference of the cap plate 300 with other external configurations may be prevented. Accordingly, during the manufacturing process of the button cell 1000, the transmission of the button cell 1000, or the use of the button cell 1000, damage to the button cell 1000 may be prevented due to the cap plate 300 and damage may be prevented to the bonding between the cap plate 300 and the case 200.

In other words, the space between the case 200 and the cap plate 300 is not welded, and the cap plate 300 does not protrude to the outside of the side wall 220 of the case 200, which could result in damage due to welding and external interference, thereby providing the protected button cell 1000.

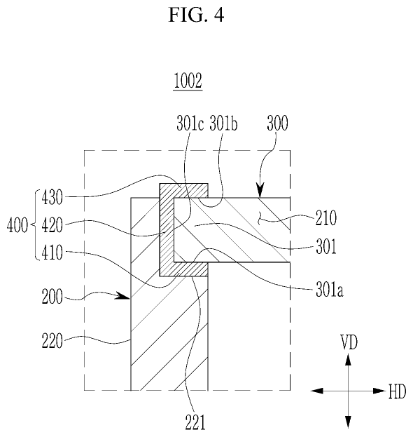

Herein, a button cell according to another embodiment is described with reference to FIG. 4.

Below, parts of the button cell according to the present embodiment that are different from the button cell according to the above-described embodiment will be described.

FIG. 4 is a cross-sectional view showing a region of a button cell, corresponding to the region “A” of FIG. 2, according to another embodiment.

Referring to FIG. 4, a bonding layer 400 of a button cell 1002 is in contact with a rear surface 301a, a side surface 301c, and a front surface 301b of an edge 301 of the cap plate 300 and surrounds the edge 301 of the cap plate 300. The bonding layer 400 includes a first part 410, a second part 420, and a third part 430. The first part 410 is in contact with the rear surface 301a of the edge 301 of the cap plate 300, the second part 420 extends from the first part 410 and is in contact with the side surface 301c of the edge 301 of the cap plate 300, and the third part 430 extends from the second part 420 and is in contact with the front surface 301b of the edge 301 of the cap plate 300. The bonding layer 400 is positioned on the step part 221 of the side wall 220 of the case 200 and includes the first part 410, the second part 420, and the third part 430, which are in contact with the rear surface 301a, the side surface 301c, and the front surface 301b of the edge 301 of the cap plate 300 which, in an embodiment, is inserted into the step part 221 by roll pressing between the case 200 and the cap plate 300, thereby preventing or substantially preventing short circuiting between the case 200 and the cap plate 300.

As described above, in the button cell 1002 according to the present embodiment, as the cap plate 300 covering the opening 210 of the case 200 connected to the first electrode 110 of the inside-accommodated electrode assembly 100 is connected to the second electrode 120 and insulated and bonded to the side wall 220 of the case 200 by the bonding layer 400, the cap plate 300 is not welded to the case 200, thereby preventing the separator 130 of the electrode assembly 100 from being damaged by welding heat, and preventing or substantially preventing a short circuit between the first electrode 110 and the second electrode 120 of the electrode assembly 100.

Also, in the button cell 1002 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1002 from being damaged due to damage of the cap plate 300 or damage of the bonding between the cap plate 300 and the case 200 during the transmitting of the button cell 1002 and the use of the button cell 1002 in the manufacturing process of the button cell 1002.

Also, in the button cell 1002 according to the present embodiment, as the bonding layer 400 surrounds the edge 301 of the cap plate 300 by including the first part 410, the second part 420, and the third part 430 which are in contact with the rear surface 301a, the side surface 301c, and the front surface 301b of the edge 301 of the cap plate 300, a distance between an exposed external surface of the case 200 and an exposed external surface of the cap plate 300 is increased, thereby preventing or substantially preventing a short circuit between the case 200 and the cap plate 300.

That is, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby preventing or substantially preventing the button cell 1002 from being damaged due to welding heat, external interference, and a short circuit.

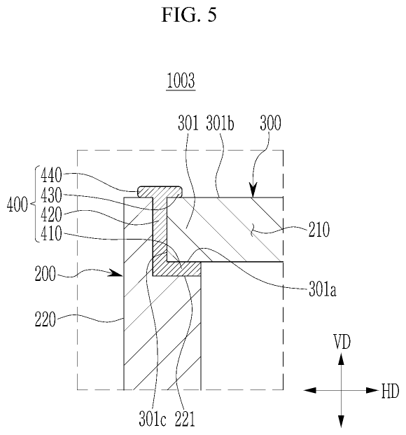

Herein, a button cell according to another embodiment is described with reference to FIG. 5.

Below, parts of the button cell according to the present embodiment that are different from the button cell according to the above-described embodiment will be described.

FIG. 5 is a cross-sectional view showing a region of a button cell, corresponding to the region “A” of FIG. 2, according to another embodiment.

Referring to FIG. 5, the bonding layer 400 of a button cell 1003 is in contact with the rear surface 301a, the side surface 301c, and the front surface 301b of the edge 301 of the cap plate 300, and the end of the side wall 220 surrounds the edge 301 of the cap plate 300. The bonding layer 400 includes the first part 410, the second part 420, the third part 430, and a fourth part 440. The first part 410 is in contact with the rear surface 301a of the edge 301 of the cap plate 300, the second part 420 extends from the first part 410 and is in contact with the side surface 301c of the edge 301 of the cap plate 300, the third part 430 extends from the second part 420 and is in contact with the front surface 301b of the edge 301 of the cap plate 300, and the fourth part 440 extends from the second part 420 and is contact with the end of the side wall 220. The bonding layer 400 is positioned on the step part 221 of the side wall 220 of the case 200 and includes the first part 410, the second part 420, the third part 430, and the fourth part 440, which are in contact with the rear surface 301a, the side surface 301c, and the front surface 301b of the edge 301 of the cap plate 300 inserted into the step part 221, and the end of the side wall 220, and, in an embodiment, by roll pressing between the case 200 and the cap plate 300, thereby preventing or substantially preventing a short circuit between the case 200 and the cap plate 300.

As described above, in the button cell 1003 according to the present embodiment, as the cap plate 300 covering the opening 210 of the case 200 connected to the first electrode 110 of the electrode assembly 100 accommodated therein is connected to the second electrode 120, and is insulated and bonded to the side wall 220 of the case 200 by the bonding layer 400, the cap plate 300 is not welded to the case 200, thereby preventing the separator 130 of the electrode assembly 100 from being damaged by welding heat, and preventing or substantially preventing a short circuit between the first electrode 110 and the second electrode 120 of the electrode assembly 100.

Also, in the button cell 1003 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1003 from being damaged due to damage of the cap plate 300 or damage of the bonding between the cap plate 300 and the case 200 during the transmitting of the button cell 1003 and the use of the button cell 1003 in the manufacturing process of the button cell 1003.

Also, in the button cell 1003 according to the present embodiment, as the bonding layer 400 surrounds the edge 301 of the cap plate 300 by including the first part 410, the second part 420, the third part 430, and the fourth part 440, which are in contact with the rear surface 301a, the side surface 301c, and the front surface 301b of the edge 301 of the cap plate 300, and the end of the side wall 220, a distance between the exposed external surface of the case 200 and the exposed external surface of the cap plate 300 is increased, thereby preventing or substantially preventing a short circuit between the case 200 and the cap plate 300.

That is, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby providing the button cell 1003 with prevention of damage due to welding heat, and prevention or substantial prevention of damage from external interference and a short circuit.

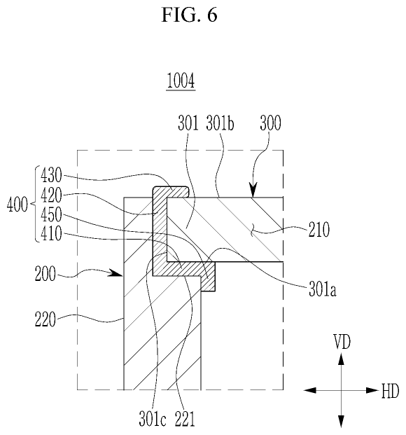

Herein, a button cell according to another embodiment is described with reference to FIG. 6.

Below, parts of the button cell according to the present embodiment that are different from the button cell according to the above-described embodiment will be described.

FIG. 6 is a cross-sectional view showing a region of a button cell, corresponding to the region “A” of FIG. 2, according to another embodiment.

Referring to FIG. 6, the bonding layer 400 of a button cell 1004 is in contact with the rear surface 301a, the side surface 301c, and the front surface 301b of the edge 301 of the cap plate 300, and an inner surface of the side wall 220, and surrounds the edge 301 of the cap plate 300. The bonding layer 400 includes the first part 410, the second part 420, the third part 430, and a fifth part 450. The first part 410 is in contact with the rear surface 301a of the edge 301 of the cap plate 300, the second part 420 extends from the first part 410 and is in contact with the side surface 301c of the edge 301 of the cap plate 300, the third part 430 extends from the second part 420 and is in contact with the front surface 301b of the edge 301 of the cap plate 300, and the fifth part 450 extends from the first part 410 and is in contact with the inner surface of the side wall 220. The bonding layer 400 is positioned on the step part 221 of the side wall 220 of the case 200 and includes the first part 410, the second part 420, the third part 430, and the fifth part 450 which are in contact with the rear surface 301a, the side surface 301c, and the front surface 301b of the edge 301 of the cap plate 300 inserted into the step part 221, and the inner surface of the side wall 220, and, in an embodiment, by roll pressing between the case 200 and the cap plate 300, thereby preventing or substantially preventing a short circuit between the case 200 and the cap plate 300.

As described above, in the button cell 1004 according to the present embodiment, as the cap plate 300 covering the opening 210 of the case 200 connected to the first electrode 110 of the assembly 100 accommodated therein is connected to the second electrode 120, and is insulated and bonded to the side wall 220 of the case 200 by the bonding layer 400, the cap plate 300 is not welded to the case 200, thereby preventing the separator 130 of the electrode assembly 100 from being damaged by welding heat, and preventing or substantially preventing a short circuit between the first electrode 110 and the second electrode 120 of the electrode assembly 100.

Also, in the button cell 1004 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1004 from being damaged due to damage of the cap plate 300 or damage of the bonding between the cap plate 300 and the case 200 during the transmitting of the button cell 1004 and the use of the button cell 1004 in the manufacturing process of the button cell 1004.

Also, in the button cell 1004 according to the present embodiment, as the bonding layer 400 surrounds the edge 301 of the cap plate 300 by including the first part 410, the second part 420, the third part 430, and the fifth part 450, which are in contact with the rear surface 301a, the side surface 301c, and the front surface 301b of the edge 301 of the cap plate 300, and the inner surface of the side wall 220, a distance between the exposed external surface of the case 200 and the exposed external surface of the cap plate 300 is increased, thereby preventing or substantially preventing a short circuit between the case 200 and the cap plate 300.

That is, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby providing the button cell 1004 with prevention of damage due to welding heat, and prevention or substantial prevention of damage from external interference and short circuit.

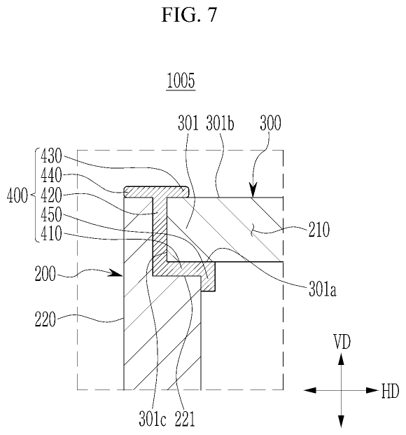

Herein, a button cell according to another embodiment is described with reference to FIG. 7.

Below, parts of the button cell according to the present embodiment that are different from the button cell according to the above-described embodiment will be described.

FIG. 7 is a cross-sectional view showing a region of a button cell, corresponding to the region “A” of FIG. 2, according to another embodiment.

Referring to FIG. 7, the bonding layer 400 of a button cell 1005 is in contact with the rear surface 301a, the side surface 301c, and the front surface 301b of the edge 301 of the cap plate 300, the end of the side wall 220, and the inner surface of the side wall 220, and surrounds the edge 301 of the cap plate 300. The bonding layer 400 includes the first part 410, the second part 420, the third part 430, the fourth part 440, and the fifth part 450. The first part 410 is in contact with the rear surface 301a of the edge 301 of the cap plate 300, the second part 420 extends from the first part 410 and is in contact with the side surface 301c of the edge 301 of the cap plate 300, the third part 430 extends from the second part 420 and is in contact with the front surface 301b of the edge 301 of the cap plate 300, the fourth part 440 extends from the second part 420 and is in contact with the end of the side wall 220, and the fifth part 450 extends from the first part 410 and is in contact with the inner surface of the side wall 220. The bonding layer 400 is positioned on the step part 221 of the side wall 220 of the case 200 and includes the first part 410, the second part 420, the third part 430, the fourth part 440, and the fifth part 450, which are in contact with the rear surface 301a, the side surface 301c, and the front surface 301b of the edge 301 of the cap plate 300 inserted into the step part 221, the end of the side wall 220, and the inner surface of the side wall 220 and, in an embodiment, by roll pressing between the case 200 and the cap plate 300, thereby preventing or substantially preventing a short circuit between the case 200 and the cap plate 300.

As described above, in the button cell 1005 according to the present embodiment, as the cap plate 300 covering the opening 210 of the case 200 connected to the first electrode 110 of the electrode assembly 100 accommodated therein is connected to the second electrode 120, and is insulated and bonded to the side wall 220 of the case 200 by the bonding layer 400, the cap plate 300 is not welded to the case 200, thereby preventing the separator 130 of the electrode assembly 100 from being damaged by welding heat, and preventing or substantially preventing a short circuit between the first electrode 110 and the second electrode 120 of the electrode assembly 100.

Also, in the button cell 1005 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1005 from being damaged due to damage of the cap plate 300 or damage of the bonding between the cap plate 300 and the case 200 during the transmitting of the button cell 1005 and the use of the button cell 1005 in the manufacturing process of the button cell 1005.

Also, in the button cell 1005 according to the present embodiment, as the bonding layer 400 surrounds the edge 301 of the cap plate 300 by including the first part 410, the second part 420, the third part 430, the fourth part 440, and the fifth part 450, which are in contact with the rear surface 301a, the side surface 301c, and the front surface 301b of the edge 301 of the cap plate 300, the end of the side wall 220, and the inner surface of the side wall 220, a distance between the exposed external surface of the case 200 and the exposed external surface of the cap plate 300 is increased, thereby preventing or substantially preventing a short circuit between the case 200 and the cap plate 300.

For example, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby providing the button cell 1005 with prevention of damage due to welding heat, and prevention or substantial prevention of damage from the external interference, and a short circuit.

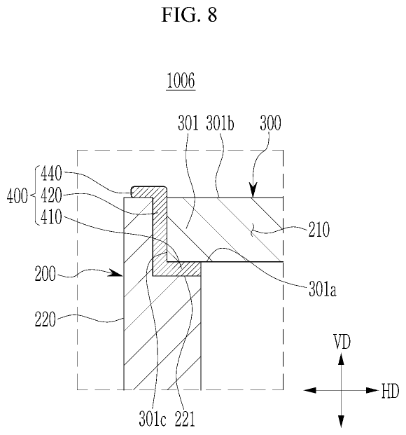

Herein, a button cell according to another embodiment is described with reference to FIG. 8.

Below, parts of the button cell according to the present embodiment that are different from the button cell according to the above-described embodiment will be described.

FIG. 8 is a cross-sectional view showing a region of a button cell, corresponding to the region “A” of FIG. 2, according to another embodiment.

Referring to FIG. 8, the bonding layer 400 of a button cell 1006 is in contact with the rear surface 301a and the side surface 301c of the edge 301 of the cap plate 300, and the end of the side wall 220, and surrounds the edge 301 of the cap plate 300. The bonding layer 400 includes a first part 410, a second part 420, and a fourth part 440. The first part 410 is in contact with the rear surface 301a of the edge 301 of the cap plate 300, the second part 420 extends from the first part 410 and is in contact with the side surface 301c of the edge 301 of the cap plate 300, and the fourth part 440 extends from the second part 420 and is in contact with the end of the side wall 220. The bonding layer 400 is positioned on the step part 221 of the side wall 220 of the case 200 and includes the first part 410, the second part 420, and the fourth part 440, which are in contact with the rear surface 301a and the side surface 301c of the edge 301 of the cap plate 300, which is inserted into the step part 221, and the end of the side wall 220, and, in an embodiment, by roll pressing between the case 200 and the cap plate 300, thereby preventing or substantially preventing a short circuit between the case 200 and the cap plate 300.

As described above, in the button cell 1006 according to the present embodiment, as the cap plate 300 covering the opening 210 of the case 200 connected to the first electrode 110 of the electrode assembly 100 accommodated therein is connected to the second electrode 120, and is insulated and bonded to the side wall 220 of the case 200 by the bonding layer 400, the cap plate 300 is not welded to the case 200, thereby preventing the separator 130 of the electrode assembly 100 from being damaged by welding heat, and preventing or substantially preventing a short circuit between the first electrode 110 and the second electrode 120 of the electrode assembly 100.

Also, in the button cell 1006 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1006 from being damaged due to damage of the cap plate 300 or damage of the bonding between the cap plate 300 and the case 200 during the transmitting of the button cell 1006 and the use of the button cell 1006 in the manufacturing process of the button cell 1006.

Also, in the button cell 1006 according to the present embodiment, as the bonding layer 400 surrounds the edge 301 of the cap plate 300 by including the first part 410, the second part 420, and the fourth part 440, which are in contact with the rear surface 301a and the side surface 301c of the edge 301 of the cap plate 300, and the end of the side wall 220, a distance between the exposed external surface of the case 200 and the exposed external surface of the cap plate 300 is increased, thereby preventing or substantially preventing a short circuit between the case 200 and the cap plate 300.

That is, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby providing the button cell 1006 with prevention of damage due to welding heat, and prevention or substantial prevention of damage from external interference, and short circuit.

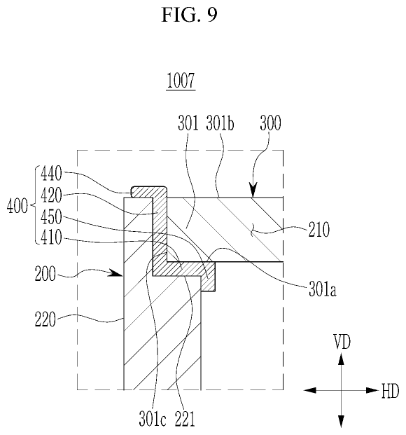

Herein, a button cell according to another embodiment is described with reference to FIG. 9.

Below, parts of the button cell according to the present embodiment that are different from the button cell according to the above-described embodiment will be described.

FIG. 9 is a cross-sectional view showing a region of a button cell, corresponding to the region “A” of FIG. 2, according to another embodiment.

Referring to FIG. 9, the bonding layer 400 of a button cell 1007 is in contact with the rear surface 301a and the side surface 301c of the edge 301 of the cap plate 300, the end of the side wall 220, and the inner surface of the side wall 220, and surrounds the edge 301 of the cap plate 300. The bonding layer 400 includes the first part 410, the second part 420, the fourth part 440, and the fifth part 450. The first part 410 is in contact with the rear surface 301a of the edge 301 of the cap plate 300, the second part 420 extends from the first part 410 and is in contact with the side surface 301c of the edge 301 of the cap plate 300, the fourth part 440 extends from the second part 420 and is in contact with the end of the side wall 220, and the fifth part 450 extends from the first part 410 and is in contact with the inner surface of the side wall 220. The bonding layer 400 is positioned on the step part 221 of the side wall 220 of the case 200 and includes the first part 410, the second part 420, the fourth part 440, and the fifth part 450, which are in contact with the rear surface 301a and the side surface 301c of the edge 301 of the cap plate 300, which is inserted into the step part 221, the end of the side wall 220, and the inner surface of the side wall 220, and, in an embodiment, by roll pressing between the case 200 and the cap plate 300, thereby preventing or substantially preventing a short circuit between the case 200 and the cap plate 300.

As described above, in the button cell 1007 according to the present embodiment, as the cap plate 300 covering the opening 210 of the case 200 connected to the first electrode 110 of the electrode assembly 100 accommodated therein is connected to the second electrode 120, and is insulated and bonded to the side wall 220 of the case 200 by the bonding layer 400, the cap plate 300 is not welded to the case 200, thereby preventing the separator 130 of the electrode assembly 100 from being damaged by welding heat and preventing or substantially preventing a short circuit between the first electrode 110 and the second electrode 120 of the electrode assembly 100.

Also, in the button cell 1007 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1007 from being damaged due to damage of the cap plate 300 or damage of the bonding between the cap plate 300 and the case 200 during the transmitting of the button cell 1007 and the use of the button cell 1007 in the manufacturing process of the button cell 1007.

Also, in the button cell 1007 according to the present embodiment, the bonding layer 400 surrounds the edge 301 of the cap plate 300 by including the first part 410, the second part 420, the fourth part 440, and the fifth part 450, which are in contact with the rear surface 301a and the side surface 301c of the edge 301 of the cap plate 300, the end of the side wall 220, and the inner surface of the side wall 220, a distance between the exposed external surface of the case 200 and the exposed external surface of the cap plate 300 is increased, thereby preventing or substantially preventing a short circuit between the case 200 and the cap plate 300.

That is, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby providing the button cell 1007 with prevention of damage due to the welding heat, and prevention or substantial prevention of damage from external interference, and short circuit.

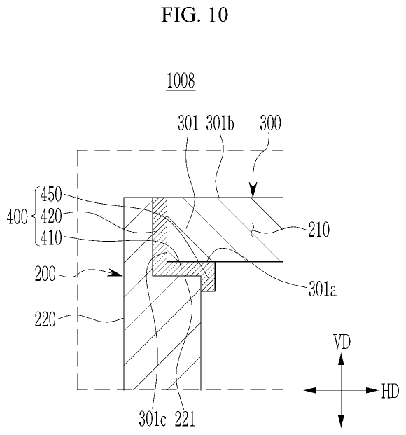

Herein, a button cell according to another embodiment is described with reference to FIG. 10.

Below, parts of the button cell according to the present embodiment that are different from the button cell according to the above-described embodiment will be described.

FIG. 10 is a cross-sectional view showing a region of a button cell, corresponding to the region “A” of FIG. 2, according to another embodiment.

Referring to FIG. 10, the bonding layer 400 of a button cell 1008 is in contact with the rear surface 301a and the side surface 301c of the edge 301 of the cap plate 300, and the inner surface of the side wall 220, and surrounds the edge 301 of the cap plate 300. The bonding layer 400 includes a first part 410, a second part 420, and a fifth part 450. The first part 410 is in contact with the rear surface 301a of the edge 301 of the cap plate 300, the second part 420 extends from the first part 410 and is in contact with the side surface 301c of the edge 301 of the cap plate 300, and the fifth part 450 extends from the first part 410 and is in contact with the inner surface of the side wall 220. The bonding layer 400 is positioned on the step part 221 of the side wall 220 of the case 200 and includes the first part 410, the second part 420, and the fifth part 450, which are in contact with the rear surface 301a and the side surface 301c of the edge 301 of the cap plate 300 inserted into the step part 221, and the inner surface of the side wall 220, and, in an embodiment, by roll pressing between the case 200 and the cap plate 300, thereby preventing or substantially preventing a short circuit between the case 200 and the cap plate 300.

As described above, in the button cell 1008 according to the present embodiment, as the cap plate 300 covering the opening 210 of the case 200 connected to the first electrode 110 of the electrode assembly 100 accommodated therein is connected to the second electrode 120, and is insulated and bonded to the side wall 220 of the case 200 by the bonding layer 400, the cap plate 300 is not welded to the case 200, thereby preventing the separator 130 of the electrode assembly 100 from being damaged by welding heat and preventing or substantially preventing a short circuit between the first electrode 110 and the second electrode 120 of the electrode assembly 100.

Also, in the button cell 1008 according to the present embodiment, as the cap plate 300 does not protrude to the outside of the horizontal direction HD and the vertical direction VD of the side wall 220 of the case 200, the cap plate 300 may be prevented from interfering with other external components, thereby preventing or substantially preventing the button cell 1008 from being damaged due to damage of the cap plate 300 or damage of the bonding between the cap plate 300 and the case 200 during the transmitting of the button cell 1008 and the use of the button cell 1008 in the manufacturing process of the button cell 1008.

Also, in the button cell 1008 according to the present embodiment, as the bonding layer 400 surrounds the edge 301 of the cap plate 300 by including the first part 410, the second part 420, and the fifth part 450, which are in contact with the rear surface 301a and the side surface 301c of the edge 301 of the cap plate 300, and the inner surface of the side wall 220, a distance between the exposed external surface of the case 200 and the exposed external surface of the cap plate 300 is increased, thereby preventing or substantially preventing a short circuit between the case 200 and the cap plate 300.

That is, the case 200 and the cap plate 300 are not welded, the cap plate 300 does not protrude to the outside of the side wall 220 of the case 200, and the distance between the external surface of the case 200 and the external surface of the cap plate 300 is increased by the bonding layer 400, thereby providing the button cell 1008 with prevention of damage due to welding heat, and prevention or substantial prevention of damage from external interference, and short circuit.

While the present disclosure has been described in connection with what are presently considered to be some practical embodiments, it is to be understood that the disclosure is not limited to the disclosed embodiments. On the contrary, the disclosure is intended to cover various modifications and equivalent arrangements included within the spirit and scope of the appended claims.

What is claimed is:

1. A button cell comprising:
an electrode assembly comprising a first electrode, a second electrode, and a separator between the first electrode and the second electrode;
a case connected to the first electrode, housing the electrode assembly, and comprising an opening exposing the electrode assembly and a side wall defining the opening;
a cap plate connected to the second electrode, insulated from and bonded to the side wall of the case, and covering the opening; and
a bonding layer located between the cap plate and the side wall of the case, and insulating and bonding between the case and the cap plate.

2. The button cell as claimed in claim 1, wherein the cap plate does not protrude to an outside of the side wall of the case.

3. The button cell as claimed in claim 2, wherein the outside of the side wall of the case comprises an outside in a horizontal direction and a vertical direction of the button cell.

4. The button cell as claimed in claim 1, wherein the side wall of the case comprises a step part that is recessed from an end of the side wall and in contact with the bonding layer.

5. The button cell as claimed in claim 4, wherein the cap plate is inserted in the step part.

6. The button cell as claimed in claim 5, wherein the bonding layer is located between the step part and an edge of the cap plate.

7. The button cell as claimed in claim 6, wherein the edge of the cap plate comprises:
a rear surface facing a bottom of the step part;
a front surface opposite to the rear surface; and
a side surface connecting the rear surface and the front surface.

8. The button cell as claimed in claim 7, wherein the bonding layer comprises a first part that is in contact with the rear surface of the edge of the cap plate.

9. The button cell as claimed in claim 8, wherein the bonding layer further comprises a second part that extends from the first part and is in contact with the side surface of the edge of the cap plate.

10. The button cell as claimed in claim 9, wherein the bonding layer further comprises a third part that extends from the second part and is contact with the front surface of the edge of the cap plate.

11. The button cell as claimed in claim 9, wherein the bonding layer further comprises a fourth part that extends from the second part and is in contact with the end of the side wall.

12. The button cell as claimed in claim 9, wherein the bonding layer further comprises a fifth part that extends from the first part and is contact with an inner surface of the side wall.

13. The button cell as claimed in claim 1, wherein the cap plate is not welded to the case.

14. The button cell as claimed in claim 1, wherein the cap plate is a flat plate that completely covers the opening.

15. The button cell as claimed in claim 1, wherein the bonding layer is in the form of a loop that is in contact with an edge of the cap plate and the side wall of the case.

16. The button cell as claimed in claim 1, wherein the electrode assembly further comprises:
a first electrode tab that extends from the first electrode and is welded to the case; and
a second electrode tab that extends from the second electrode and is welded to the cap plate.

17. The button cell as claimed in claim 1, wherein
the case has a same polarity as the first electrode, and
the cap plate has a same polarity as the second electrode.
